(19) United States
(12) Patent Application Publication
(10) Pub. No.: US 2020/0070100 A1
(43) Pub. Date: Mar. 5, 2020

(54) VARIABLE-DIAMETER SPINNING NOZZLE AND PROCESSING DEVICES FOR HOLLOW FIBER MEMBRANE BUNDLE AND MEMBRANE MODULE

(71) Applicant: Dongguan University of Technology, Dongguan (CN)

(72) Inventors: Simin Huang, Dongguan (CN); Kui He, Dongguan (CN); Wuzhi Yuan, Dongguan (CN); Minlin Yang, Dongguan (CN)

(21) Appl. No.: 16/370,641

(22) Filed: Mar. 29, 2019

(30) Foreign Application Priority Data
Sep. 3, 2018 (CN) 201811021108.3

(51) Int. Cl. B01D 69/08; B01D 63/02; B01D 67/00; D01D 5/24

(52) U.S. Cl. CPC B01D 69/085; B01D 63/021; D10B 2505/04; D01D 5/24; B01D 2323/42; B01D 67/0016

(57) ABSTRACT

The present invention relates to a variable-diameter spinning nozzle, processing devices for hollow fiber membrane bundle and membrane module. The variable-diameter spinning nozzle comprises a center round tube, a middle round tube and an external chamber which are sequentially nested, and a first drive mechanism for driving the middle round tube to move vertically upwards and downwards. The bottoms of the center round tube, the middle round tube and the external chamber are leveled. The variable-diameter spinning nozzle provided by present invention obtains membrane fiber by adjusting the location of the middle round tube, and this membrane fiber involves membrane fiber heads with relatively large diameter on both ends and a membrane fiber middle section with relatively small diameter. In the subsequent process of binding and assembly of membrane module, porosity of the membrane fiber middle section can be adjusted by controlling a diameter ratio of the membrane fiber head to the membrane fiber middle section, and thus arbitrary fill density and regular arrangement of membrane module are achieved.

### CROSS-REFERENCE TO RELATED APPLICATION

This application claims priority to Chinese Patent Application No. 201811021108.3, filed on Sep. 3, 2018, the contents of which are incorporated herein by reference in their entirety.

### TECHNICAL FIELD OF THE INVENTION

The present invention relates to a technical field of hollow fiber membrane module, and in particular relates to a variable-diameter spinning nozzle and processing devices for hollow fiber membrane bundle and membrane module.

### BACKGROUND OF THE INVENTION

Membrane separation technology is widely used in desalination of seawater, water treatment, biomedical treatment and many other modern industrial technical fields. Membrane module is a key component in a variety of membrane separation industries, and its processing technology and related devices have important economic value. However, at present, the processing technology of module using hollow fiber membrane has drawbacks such as failure to achieve mechanization, low fill density and poor consistency of module performance. With increasing use of the membrane separation technology, automation of the processing of the membrane module and higher fill density are required.

China patent 104874292A discloses an anti-pollution and easy to clean hollow fiber membrane module and preparation method thereof. It mainly processes with manual method and did not achieve automation of the process. China patent CNP201710459WZH discloses a method of producing hollow fiber membrane module and device thereof. It achieves regular arrangement of hollow fiber membrane by using membrane fiber bracket, but fill density of the membrane module is low.

Therefore, developing an automated technology and equipment for producing hollow fiber membrane module in arbitrary fill density and regular arrangement is extremely important to application of membrane separation technology.

### BRIEF SUMMARY OF THE INVENTION

The present invention aims to provide a variable-diameter spinning nozzle and overcome the drawbacks of present technology, including failure to achieve mechanization, low fill density and poor consistency of module performance in processing of the hollow fiber membrane module. The variable-diameter spinning nozzle provided by the present invention obtains membrane fibers by adjusting the location of a middle round tube, and such membrane fiber involves membrane fiber heads with relatively large diameter on both ends and a membrane fiber middle section with relatively small diameter. In the subsequent process of binding and assembly of the membrane module, porosity of the membrane fiber middle section can be adjusted by controlling a diameter ratio of the membrane fiber head to the membrane fiber middle section, and thus arbitrary fill density and regular arrangement of membrane module are achieved.

The present invention also aims to provide a processing device for hollow fiber membrane bundle.

The present invention also aims to provide a processing device for hollow fiber membrane module.

In order to achieve the abovementioned objectives, the technical solution adopted by the present invention is as follows:

A variable-diameter spinning nozzle, comprises a center round tube, a middle round tube and an external chamber which are sequentially nested, and a first drive mechanism for driving the middle round tube to move vertically upwards and downwards; bottoms of the center round tube, the middle round tube and the external chamber are leveled.

The variable-diameter spinning nozzle provided by the present invention can obtain variable-diameter membrane fibers by mainly utilizing the following principle and process. When the center round tube, the middle round tube and the external chamber are leveled, the center round tube is filled with a volatile solution and the middle round tube is filled with a stock spinning solution. Fiber membrane with small diameter can be obtained through spinning, and hollow fiber membrane with small diameter is obtained after the volatile solution is volatized. While using the first drive mechanism to drive the middle round tube to move vertically upwards, the stock spinning solution in the center round tube will flow into a hollow chamber between the external chamber and the middle round tube along the bottom of the middle round tube. Thereby, hollow fiber membrane with large diameter is obtained.

The variable-diameter hollow fiber membrane obtained by the present invention is cropped into membrane fiber sections which have membrane fiber heads with large diameter on both ends and membrane fiber middle section with small diameter. In the subsequent processes of binding of hollow fiber membrane bundles and assembly of hollow fiber membrane module, porosity of the middle section can be adjusted by controlling the diameter ratio of the membrane fiber head to the middle section. Arbitrary fill density and regular arrangement of the hollow fiber membrane module are achieved.

The length, inner diameter and outer diameter of the hollow fiber membrane can be adjusted with spinning time, and inner diameters and outer diameters of the center round tube, the middle round tube and the external chamber.

Preferably, the top of middle round tube is sealed and the upper part is provided with a feeding inlet for feeding.

Conventional drive mechanisms in the prior art can all be used for the vertically upwards and downwards movement of the middle round tube implemented in the present invention. In the present invention, it is achieved by using the following structure.

Preferably, said middle round tube protrudes from said center round tube and the external chamber. Said first drive mechanism includes a first gearwheel, a second gearwheel and a first motor. The first gearwheel is disposed at a protruding portion of the middle round tube, the second gearwheel engages with the first gearwheel and the first motor drives the second gearwheel to move.

The first motor drives the second gearwheel to move by meshing transmission, and thus achieving the vertically upwards and downwards movement of the middle round tube.

A processing device for hollow fiber membrane bundle, comprises the abovementioned variable-diameter spinning nozzle, a first feeding mechanism, a second feeding mechanism, a collecting structure, a cropping mechanism and an automatic binding machine; the first feeding mechanism is used to feed the center round tube, the second feeding mechanism is used to feed the middle round tube, the collecting structure is used to collect membrane fiber obtained by spinning of said variable-diameter spinning nozzle, the cropping mechanism is used to crop the membrane fiber from the collecting structure into membrane fiber sections and the automatic binding machine is used to bind said membrane fiber sections.

Firstly, the processing device for hollow fiber membrane bundle obtains variable-diameter hollow fiber membrane, and then collects, crops and binds the variable-diameter hollow fiber membrane to obtain the hollow fiber membrane bundle. Specific principle and process are as follows: the first feeding mechanism is used to feed a volatile solution to the center round tube, the second feeding mechanism is used to feed a stock spinning solution to the middle round tube, and the variable-diameter membrane fiber is obtained by controlling the vertically upwards and downwards movement of the middle round tube. After that, the collecting structure is used to collect the membrane fiber and the cropping mechanism is used to crop the membrane fiber to obtain membrane fiber sections. These membrane fiber sections include membrane fiber heads with large diameter on both ends and a membrane fiber middle section with small diameter in the middle. Then, the automatic binding machine is used to bind the membrane fiber sections to obtain membrane fiber bundles. The porosity of the middle section can be adjusted by controlling the diameter ratio of the membrane fiber head to the middle section, and thus arbitrary fill density and regular arrangement of hollow fiber membrane module are achieved.

Preferably, said first feeding mechanism includes an internal coagulating bath device connected with said center round tube.

More preferably, said first feeding mechanism also includes a flow meter, a first pump and a first valve which are sequentially configured at the connecting position between said internal coagulating bath device and the center round tube.

The first feeding mechanism can achieve continuous feeding to the center round tube of the variable-diameter spinning nozzle, and adjust the size and speed of flow.

Preferably, said second feeding mechanism includes a stock spinning solution tank connected with said middle round tube.

More preferably, said second feeding mechanism also includes a second pump and a second valve which are sequentially configured at the connecting position between said stock spinning solution tank and the middle round tube.

The second feeding mechanism can achieve continuous feeding to the middle round tube of the variable-diameter spinning nozzle.

Preferably, said collecting structure includes an external coagulating bath device, a first membrane fiber guiding wheel, a membrane fiber roll and a second drive mechanism. The first membrane fiber guiding wheel is configured within said external coagulating bath device and the second drive mechanism drives said membrane fiber roll to rotate.

The collecting structure can achieve automatic winding the membrane fiber around the membrane fiber roll. Solution is contained in the external coagulating bath device, and the first membrane fiber guiding wheel is placed in the solution to facilitate further coagulation of the membrane fiber. Membrane fiber obtained by the variable-diameter spinning nozzle is wound on the first membrane fiber guiding wheel and around the membrane fiber roll. The second drive mechanism is used to drive the membrane fiber roll to rotate, and thus continuous winding and collection of the membrane fiber are achieved.

Conventional drive mechanism in the prior art can all be used for rotating the membrane fiber roll in the present invention.

Preferably, said second drive mechanism is a motor.

Preferably, said cropping mechanism includes a groove, a second membrane fiber guiding wheel and a first cropping mechanism. The groove is configured on a platform, the second membrane fiber guiding wheel is configured on said groove and the first cropping mechanism is used to crop the membrane fiber.

The cropping mechanism can achieve automatically cropping the membrane fiber into membrane fiber sections. The membrane fiber is wound on the second membrane fiber guiding wheel and placed in the groove. By rotating the membrane fiber roll, the membrane fiber is then driven to move along the groove and extends out of the platform, and then the membrane fiber sections are obtained by cropping with the first cropping mechanism.

Conventional cropping mechanism being able to crop membrane fiber in the art can all be used in the present invention.

Preferably, the first cropping mechanism is a membrane fiber scissor.

Preferably, said automatic binding machine includes a membrane fiber sleeve and a mechanical arm. The membrane fiber sleeve is used to contain the membrane fiber sections and the mechanical arm is used to fit binding straps on both ends of the membrane fiber sections and to tie the membrane fiber sections up. Said membrane fiber sleeve hangs on a supporting bracket.

The automatic binding machine can achieve automatic binding of the membrane fiber sections and obtain hollow fiber membrane bundle. Firstly, the membrane fiber is placed in the membrane fiber sleeve, so that the membrane fiber heads protrude from the sleeve. Then, the mechanical arm is used to fit the binding straps on the membrane fiber heads and to tie the membrane fiber sections up, and the hollow fiber membrane bundle is obtained.

The present invention also claims to protect a processing device for hollow fiber membrane module, which includes the processing device for hollow fiber membrane bundle, a membrane module for containing the membrane fiber bundle, a glue dispensing mechanism and a second cropping mechanism for cropping the membrane fiber bundle.

The hollow fiber membrane bundle is placed in the membrane module and the glue dispensing mechanism dispenses the glue. Then, the second cropping mechanism is used to crop the membrane fiber heads on both ends of the binding straps, and the hollow fiber membrane module is obtained.

Preferably, said membrane module includes a membrane module shell, sealing boards and module sealing heads. The membrane module shell has upper and lower openings, the sealing boards are configured to be detachable from both ends of said membrane module shell and the module sealing heads are installed on upper and lower end surfaces of said membrane module shell.

Hollow fiber membrane module is obtained by cooperation of the membrane module and other components provided by the present invention. The hollow fiber membrane bundles are placed within the membrane module shell and dispensed with glue. Then, the sealing boards are sealed and the module sealing heads are installed, and the hollow fiber membrane module is now obtained.

Preferably, said processing device for the hollow fiber membrane module also includes a centrifuging mechanism for centrifuging said membrane module.

The centrifuging mechanism can accelerate coagulation of the glue. Provision of the sealing boards can prevent the glue from being thrown out during the process of centrifuging.

Preferably, said glue dispensing mechanism is a glue dispenser. Said second cropping mechanism is a membrane fiber scissor.

In comparison with the prior art, beneficial effects of the present invention are described in the following.

With adjustment of the position of the middle round tube, membrane fiber obtained by the variable-diameter spinning nozzle provided by the present invention includes membrane fiber heads with relatively large diameter on both ends and a membrane fiber middle section with relatively small diameter. In the subsequent processes of binding of hollow fiber membrane bundles and assembly of hollow fiber membrane module, porosity of the membrane fiber middle section can be adjusted by controlling a diameter ratio of the membrane fiber heads to the membrane fiber middle section. Thus, arbitrary fill density and regular arrangement of hollow fiber membrane module are achieved.

### BRIEF DESCRIPTION OF THE DRAWINGS

FIG. 1 is a structure diagram of a variable-diameter spinning nozzle provided by the first embodiment.

FIG. 2 is a structure diagram of membrane fiber obtained by spinning of the variable-diameter spinning nozzle provided by the first embodiment.

FIG. 3 is a structure diagram of a processing device for hollow fiber membrane bundle provided by the second embodiment.

FIG. 4 is a structure diagram of a cropping mechanism and an automatic binding machine in the second embodiment.

FIG. 5 is a structure diagram of bound membrane fiber bundles in the second embodiment.

FIG. 6 is a structure diagram of a membrane module in third embodiment. Therein, 1 represents variable-diameter spinning nozzle, 11 represents center round tube, 12 represents middle round tube, 121 represents feeding inlet, 13 represents external chamber, 14 represents first drive mechanism, 141 represents first gearwheel, 142 represents second gearwheel, 143 represents first motor; 2 represents first feeding mechanism, 21 represents internal coagulating bath device, 22 represents flow meter, 23 represents first pump, 24 represents first valve; 3 represents second feeding mechanism, 31 represents stock spinning solution tank, 32 represents second pump, 33 represents second valve; 4 represents collecting structure, 41 represents external coagulating bath device, 42 represents first membrane fiber guiding wheel, 43 represents membrane fiber roll, 44 represents second drive mechanism; 5 represents cropping mechanism, 51 represents platform, 52 represents groove, 53 represents second membrane fiber guiding wheel, 54 represents first cropping mechanism; 6 represents automatic binding machine, 61 represents membrane fiber sleeve, 62 represents binding strap, 63 represents mechanical arm, 64 represents supporting bracket; 7 represents membrane module, 71 represents membrane module shell, 72 represents sealing board, 73 represents module sealing head; 8 represents glue dispensing mechanism, 9 represents second cropping mechanism; a represents membrane fiber, al represents membrane fiber head, a2 represents membrane fiber middle section; b represents membrane fiber bundle.

### DETAILED DESCRIPTION OF THE INVENTION

In order to explain the purpose, technical solutions and benefits of the present invention more clearly, the present invention will be further illustrated in detail with the accompanied drawings and specific embodiments. It should be understood that specific embodiments described herein are only used to illustrate the present invention rather than to limit the scope of the present invention. Furthermore, technical features involved in every embodiment of the present invention and described in the following, can cooperate with one another as long as they do not constitute conflict.

It needs to be noted that when a component is identified as “configured at” or “disposed at” another component, it can either be placed directly on top of another component or within another component. When a component is identified as “connecting” another component, it can either connect directly to another component or may place within another component simultaneously.

### First Embodiment

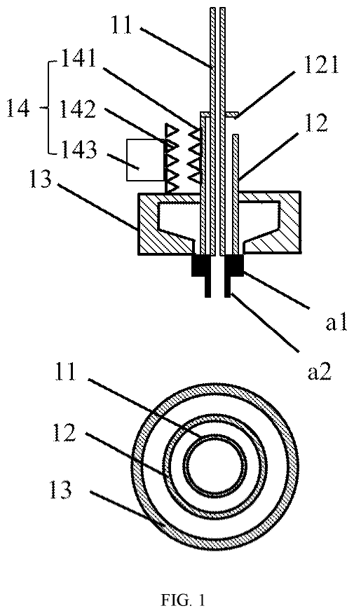

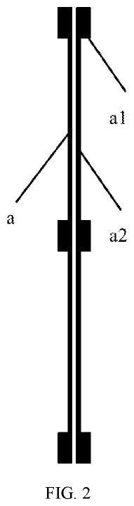

As shown in FIGS. 1 and 2, this embodiment provides a variable-diameter spinning nozzle, comprising a center round tube 11, a middle round tube 12 and an external chamber 13 which are sequentially nested, and a first drive mechanism 14 for driving the middle round tube 12 to move vertically upwards and downwards. The bottoms of the center round tube 11, the middle round tube 12 and the external chamber 13 are leveled.

In this embodiment, top part of the middle round tube 12 is sealed and the upper part is provided with a feeding inlet 121 for feeding.

In this embodiment, the middle round tube 12 protrudes from the center round tube 11 and the external chamber 12. The first drive mechanism 14 includes a first gearwheel 141, a second gearwheel 142 and a first motor 143. The first gearwheel 141 is disposed at a protruding portion of the middle round tube 12, the second gearwheel 142 engages with the first gearwheel 141 and the first motor 143 drives the second gearwheel to move. The first motor 143 drives the second gearwheel 142 to move, and by meshing transmission, achieving the vertically upwards and downwards movement of the middle round tube 12.

The variable-diameter spinning nozzle provided by this embodiment can obtain variable-diameter membrane fiber, by mainly utilizing the following principle and process. When the center round tube, the middle round tube and the external chamber are leveled, the center round tube is filled with a volatile solution and the middle round tube is filled with a stock spinning solution. Fiber membrane with small diameter can be obtained through spinning, and hollow fiber membrane with small diameter is obtained after the volatile solution is volatized. While using the first drive mechanism to drive the middle round tube to move vertically upwards (i.e. move vertically up to that the upper end surface thereof levels with the center round tube), the stock spinning solution in the middle round tube will flow into the hollow chamber between the external chamber and the middle round tube along the bottom of the middle round tube. Thereby, hollow fiber membrane with large diameter is obtained. By adjusting the frequency and duration of the vertical movement of the middle round tube, membrane fiber is obtained which is alternately arranged with large diameter and small diameter successively as shown in FIG. 2.

The length, inner diameter and outer diameter of the hollow fiber membrane can be adjusted with spinning time, and inner diameters and outer diameters of the center round tube, the middle round tube and the external chamber.

Membrane fiber sections involving membrane fiber heads with large diameter on both ends and a membrane fiber middle section with small diameter in the middle are obtained by cropping the variable-diameter hollow fiber membrane. In the subsequent process of binding and assembly of a membrane module, porosity of the middle section can be adjusted by controlling a diameter ratio of the membrane fiber head to the middle section, and thus arbitrary fill density and regular arrangement of the membrane module are achieved.

### Second Embodiment

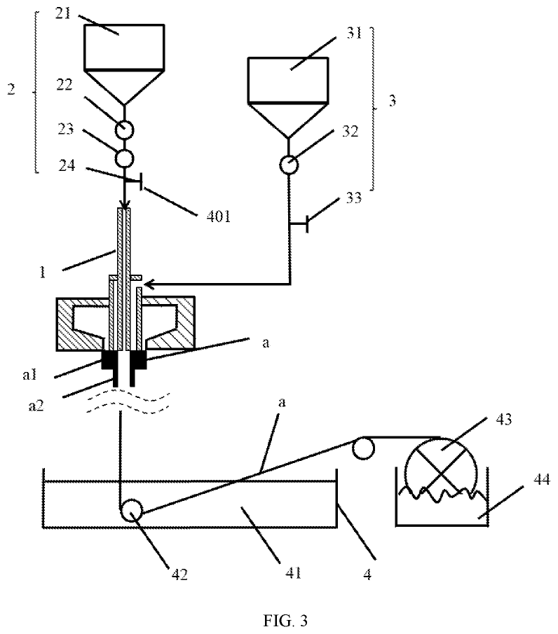

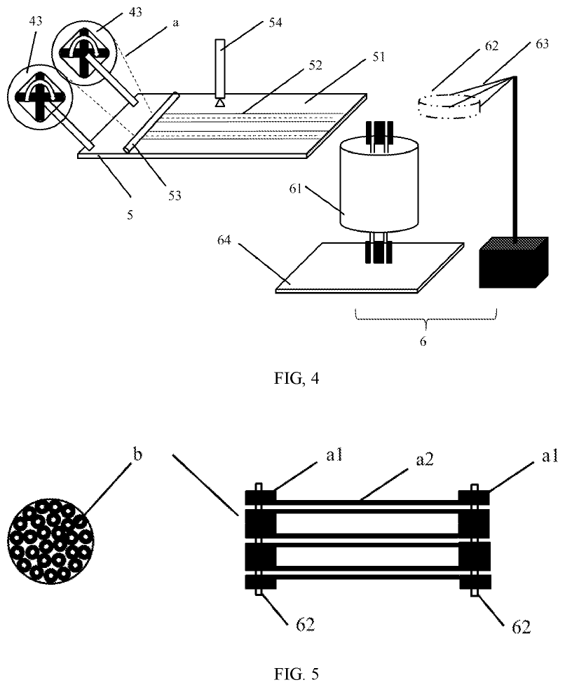

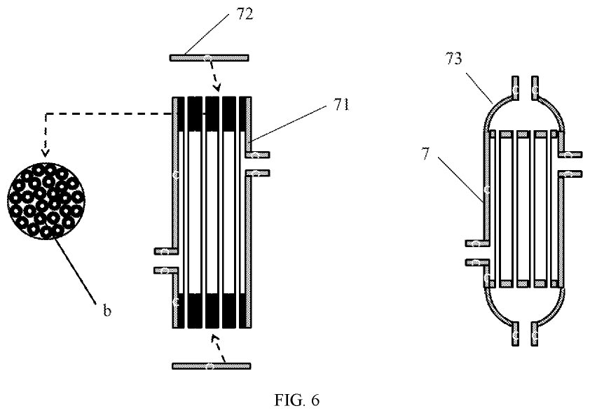

Based on the first embodiment and referred to FIGS. 3, 4 and 5, this embodiment further provides a processing device for hollow fiber membrane bundle, comprising the variable-diameter spinning nozzle 1 from the first embodiment, a first feeding mechanism 2, a second feeding mechanism 3, a collecting structure 4, acropping mechanism 5 and an automatic binding machine 6. The first feeding mechanism 2 is used to feed the center round tube 11, the second feeding mechanism 3 is used to feed the middle round tube 12, the collecting structure 4 is used to collect the membrane fiber obtained by spinning of the variable-diameter spinning nozzle 1, the cropping mechanism 5 is used to crop the membrane fiber from the collecting structure into membrane fiber sections and the automatic binding machine 6 is used to bind the membrane fiber sections.

In this embodiment, the first feeding mechanism 2 includes an internal coagulating bath device 21 connected with the center round tube 11. The first feeding mechanism 2 also includes a flow meter 22, a first pump 23 and a first valve 24 which are sequentially disposed at the connecting position between the internal coagulating bath device 21 and the center round tube 11. The first feeding mechanism can achieve continuous feeding to the center round tube of the variable-diameter spinning nozzle and adjust the size and speed of flow.

In this embodiment, the second feeding mechanism 3 includes a stock spinning solution tank 31 connected with the middle round tube 12. The second feeding mechanism 3 includes a second pump 32 and a second valve 33 which are sequentially disposed at the connecting position between the stock spinning solution tank 31 and the middle round tube 12. The second feeding mechanism can achieve continuous feeding to the middle round tube of the variable-diameter spinning nozzle.

In this embodiment, the collection structure 4 includes an external coagulating bath device 41, a first membrane fiber guiding wheel 42, a membrane fiber roll 43 and a second drive mechanism 44. The first membrane fiber guiding wheel 42 is disposed within the external coagulating bath device 41 and the second drive mechanism 44 drives the membrane fiber roll 43 to rotate.

Particularly, the collecting structure can achieve automatic winding the membrane fiber around the membrane fiber roll. Solution is contained in the external coagulating bath device, and the first membrane fiber guiding wheel is placed in the solution to facilitate further coagulation of the membrane fiber. Membrane fiber obtained by the variable-diameter spinning nozzle is wound on the first membrane fiber guiding wheel and around the membrane fiber roll. The second drive mechanism is used to drive the membrane fiber roll to rotate, and thus continuous winding and collection of the membrane fiber are achieved. In an example therein, the second drive mechanism can be a motor.

In this embodiment, the cropping mechanism 5 includes a groove 52, a second membrane fiber guiding wheel 53 and a first cropping mechanism 54. The groove 52 is configured on a platform 51, the second membrane fiber guiding wheel 53 is disposed on the groove 52 and the first cropping mechanism 54 is used to crop the membrane fiber.

Particularly, the cropping mechanism can achieve automatically cropping the membrane fiber into membrane fiber sections. The membrane fiber is wound on the second membrane fiber guiding wheel and placed in the groove. By rotating the membrane fiber roll, the membrane fiber is then driven to move along the groove and extends out of the platform, and then the membrane fiber sections are obtained by cropping with the first cropping mechanism.

In an example therein, the first cropping mechanism 54 is a membrane fiber scissor. Obviously, conventional cropping mechanisms in the art which are able to crop the membrane fiber can all be applied in present invention.

In this embodiment, the automatic binding machine 6 includes a membrane fiber sleeve 61 and a mechanical arm 63. The membrane fiber sleeve 61 is used to contain the membrane fiber sections and the mechanical arm 63 is used to fit binding straps 62 on both ends of the membrane fiber and to tie the membrane fiber sections up. The membrane fiber sleeve 61 hangs on a supporting bracket 64.

In particular, the automatic binding machine can achieve automatic binding of the membrane fiber sections and obtain membrane bundles. Firstly, the membrane fiber is placed in the membrane fiber sleeve, so that the membrane fiber heads protrude from the sleeve. Then, the mechanical arm is used to fit the binding straps on the membrane fiber heads and to tie the membrane fiber sections up, and the membrane bundle is obtained.

The processing device for hollow fiber membrane bundle provided by this embodiment firstly uses the variable-diameter spinning nozzle to obtain hollow fiber membrane, and then the hollow fiber membrane bundle is obtained by cropping and binding the hollow fiber membrane. Specific principle and process are as follows. The first feeding mechanism is used to feed the center round tube with a volatile solution and the second feeding mechanism is used to feed the middle round tube with a stock spinning solution. Variable-diameter membrane fiber is obtained by controlling the vertically upwards and downwards movement of the middle round tube. After that, the collecting structure is used to collect membrane fiber and the cropping mechanism is used to crop the membrane fiber to obtain membrane fiber sections. These membrane fiber sections include membrane fiber heads with large diameter on both ends and a membrane fiber middle section with small diameter in the middle. Then, the automatic binding machine is used to bind the membrane fiber sections to obtain membrane fiber bundle.

### Third Embodiment

Referred to FIG. 6, this embodiment further provides a processing device for hollow fiber membrane module, comprising the processing device for hollow fiber membrane bundle, a membrane module 7 for containing the membrane fiber bundle, a glue dispensing mechanism 8 and a second cropping mechanism 9 for cropping the membrane fiber bundle.

In specific, the hollow fiber membrane bundle is placed in the membrane module and the glue dispensing mechanism dispenses the glue. Then, the second cropping mechanism is used to crop the membrane fiber heads on both ends of the binding straps, and the hollow fiber membrane module is obtained.

In this embodiment, the membrane module 7 includes a membrane module shell 71, sealing boards 72 and module sealing heads 73. The membrane module shell 71 has upper and lower openings, the sealing boards 72 are configured to be detachable from both ends of the membrane module shell 71 and the module sealing heads 73 are installed on upper and lower end surfaces of the membrane module shell 71.

In specific, the hollow fiber membrane module is obtained by cooperation of the membrane module and other components provided by the present invention. The hollow fiber membrane bundles are placed within the membrane module shell and dispensed with glue. Then, the sealing boards are sealed and the module sealing heads are installed, and the hollow fiber membrane module is now obtained.

In this embodiment, the processing device for hollow fiber membrane module also includes a centrifuging mechanism for centrifuging the membrane module. The centrifuging mechanism can accelerate coagulation of the glue. Provision of the sealing boards can prevent the glue from being thrown out during the process of centrifuging.

In a particular example, the glue dispensing mechanism 8 is a glue dispenser. The second cropping mechanism 9 is a membrane fiber scissor.

In conclusion, the variable-diameter spinning nozzle provided by the present invention obtains membrane fiber by adjusting the location of the middle round tube, and the membrane fiber involves membrane fiber heads with relatively large diameter on both ends and a membrane fiber middle section with relatively small diameter. In the subsequent process of binding of hollow fiber membrane bundle and assembly of membrane module, the porosity of the membrane fiber middle section can be adjusted by controlling a diameter ratio of the membrane fiber head to the membrane fiber middle section, and thus arbitrary fill density and regular arrangement of membrane module are achieved.

The above embodiments are merely preferred embodiments of the present invention, and the scope of the present invention is not limited thereto, and any insubstantial changes or substitutions made by those skilled in the art based on the present invention belong to the scope of protection claimed in the present invention.

1. A variable-diameter spinning nozzle, characterized in that the variable-diameter spinning nozzle comprises a center round tube (11), a middle round tube (12) and an external chamber (13) which are sequentially nested, and a first drive mechanism (14) for driving the middle round tube (12) to move vertically upwards and downwards; bottoms of the center round tube (11), the middle round tube (12) and the external chamber (13) are leveled.

2. The variable-diameter spinning nozzle of claim 1, wherein the middle round tube (12) protrudes from the center round tube (11) and the external chamber (13), said first drive mechanism (14) includes a first gearwheel (141), a second gearwheel (142) and a first motor (143); the first gearwheel (141) is disposed at a protruding portion of said middle round tube (12), the second gearwheel (142) engages with said first gearwheel and the first motor (143) drives said second gearwheel to move.

3. A processing device for hollow fiber membrane bundle, characterized in that it comprises the variable-diameter spinning nozzle (1) of claim 1, a first feeding mechanism (2), a second feeding mechanism (3), a collecting structure (4), a cropping mechanism (5) and an automatic binding machine (6); the first feeding mechanism (2) is used to feed the center round tube (11), the second feeding mechanism (3) is used to feed the middle round tube (12), the collecting structure (4) is used to collect membrane fiber obtained by spinning of said variable-diameter spinning nozzle (1), the cropping mechanism (5) is used to crop the membrane fiber from the collecting structure (4) into membrane fiber sections and the automatic binding machine (6) is used to bind said membrane fiber sections.

4. The processing device for hollow fiber membrane bundle of claim 3, wherein said first feeding mechanism (2) includes an internal coagulating bath device (21) connected with said center round tube (11); said first feeding mechanism (2) also includes a flow meter (22), a first pump (23) and a first valve (24) which are sequentially disposed at the connecting position between said internal coagulating bath device (20) and the center round tube (11).

5. (canceled)

6. (canceled)

7. The processing device for hollow fiber membrane bundle of claim 3, wherein said second feeding mechanism (3) includes a stock spinning solution tank (31) connected with said middle round tube (12); said second feeding mechanism (3) also includes a second pump (32) and a second valve (33) which are sequentially disposed at the connecting position between said stock spinning solution tank (31) and the middle round tube (12).

8. (canceled)

9. (canceled)

10. The processing device for hollow fiber membrane bundle of claim 3, wherein said collecting structure (4) includes an external coagulating bath device (41), a first membrane fiber guiding wheel (42), a membrane fiber roll (43) and a second drive mechanism (44); the first membrane fiber guiding wheel (42) is disposed within said external coagulating bath device (41) and the second drive mechanism (44) drives said membrane fiber roll (43) to rotate.

11. The processing device for hollow fiber membrane bundle of claim 10, wherein said cropping mechanism (5) includes a groove (52), a second membrane fiber guiding wheel (53) and a first cropping mechanism (54); the groove (52) is configured on a platform (51), the second membrane fiber guiding wheel (53) is disposed on said groove (52) and the first cropping mechanism (54) is used to crop the membrane fiber.

12. (canceled)

13. (canceled)

14. The processing device for hollow fiber membrane bundle of claim 3, wherein said automatic binding machine (6) includes a membrane fiber sleeve (61) and a mechanical arm (63); the membrane fiber sleeve (61) is used to contain the membrane fiber sections and the mechanical arm (63) is used to fit binding straps (62) on both ends of the membrane fiber sections and to tie the membrane fiber sections up; said membrane fiber sleeve (61) hangs on a supporting bracket (64).

15. (canceled)

16. A processing device for hollow fiber membrane module, comprising the processing device for hollow fiber membrane bundle of claim 3, a membrane module (7) for containing the membrane fiber bundle, a glue dispensing mechanism (8) and a second cropping mechanism (9) for cropping the membrane fiber bundle.

17. The processing device for hollow fiber membrane module of claim 16, wherein said membrane module (7) comprises a membrane module shell (71), sealing boards (72) and module sealing heads (73); the membrane module shell (71) has an upper opening and a lower opening, the sealing boards (72) are configured to be detachable from both ends of said membrane module shell (71) and the module sealing heads (73) are installed on upper and lower end surfaces of said membrane module shell (7).
